(19) United States
(12) Patent Application Publication
(10) Pub. No.: US 2026/0249831 A1
(43) Pub. Date: Aug. 27, 2026

(54) METHOD FOR CHECKING A VEHICLE BRAKING SYSTEM

(71) Applicant: ZF Active Safety GmbH, Koblenz (DE)

(72) Inventors: Christoph PROBST, Bendorf (DE); Daniel SUTEDJA, Koblenz (DE); Simon WEIDENFELLER, Koblenz (DE)

(21) Appl. No.: 19/537,726

(22) Filed: Feb. 12, 2026

(30) Foreign Application Priority Data
Feb. 25, 2025 (DE) 102025107002.4

(51) Int. Cl. B60T 17/22

(52) U.S. Cl. CPC B60T 17/226; B60T 17/225

(57) ABSTRACT

In a method for checking a vehicle's braking system for leaks, a braking request is detected when the vehicle is stationary. The braking request is modified by means of a predetermined pressure curve which includes a pressure above a detection threshold value, and an electrofluidic pressure-generating unit is controlled with the predetermined pressure curve. Pressure values associated with a first and/or second brake circuit are detected and compared with the predetermined pressure curve, wherein deviation values are determined. Fault indications are detected if at least one deviation value exceeds a predetermined threshold value.

### TECHNICAL FIELD

The invention relates to a method for checking a vehicle's braking system for leaks.

### BACKGROUND

A known method for this purpose is part of a hydraulic test sequence that is performed automatically during maintenance, for example. However, this naturally does not allow leaks or low compression in the hydraulic lines to be detected regularly before driving.

One focus of fault detection during normal driving is currently on a brake fluid sensor, but this can only detect a low fluid level in the brake fluid reservoir. It is not possible to locate a leak in the braking system. In addition, such sensors are expensive.

However, with braking systems that do not have hydraulically separated and therefore redundant brake circuits becoming increasingly common, it is important to detect leaks at an early stage in order to ensure safe driving behaviour. Such braking systems are common, for example, in vehicles for autonomous or semi-autonomous driving.

### SUMMARY

The object of the invention is therefore to present a flexible, simple and cost-effective method for checking a vehicle's braking system.

This object is achieved by a method for checking a vehicle's braking system for leaks, wherein the braking system has a first and a second brake circuit, each with at least one pressure port, and each of the pressure ports can be coupled to an associated brake actuator of a wheel of the vehicle, as well as an electrofluidic pressure-generating unit that is in fluid communication with the first and second brake circuits, with the steps of:
detecting a braking request when the vehicle is stationary,
modifying the braking request by means of a predetermined pressure curve which includes a pressure above a detection threshold value, and controlling the electrofluidic pressure-generating unit with the predetermined pressure curve,
detecting pressure values associated with the first and/or second brake circuit,
comparing the pressure values with the predetermined pressure curve and determining deviation values, and
detecting a fault indication if at least one deviation value exceeds a predetermined threshold value.

During braking while the vehicle is stationary, the absolute level of braking force has no effect on the behaviour of the vehicle as long as it is above the desired braking force. Such braking operations can therefore be used without any problems to specifically modify the braking operation by means of a predetermined pressure curve that is tailored to a test of the braking system.

The pressure curve can be specifically adjusted in terms of both brake pressure and time so that the vehicle user is not disturbed by the braking system test and yet a reliable statement can be made about the condition of the braking system. If the detected pressure value measured in the braking system does not correspond to the expected pressure curve, it is therefore clear that there is a fault, as the targeted adjustment of the brake pressure ensures that the braking process involves a pressure above the detection threshold value for a fault.

The detection threshold value must be set so that a leak in one of the brake circuits is detected within the time available for the check and, optionally, also so high that insufficient compression in one of the brake circuits can also be detected during the check.

In addition, it is ensured that the check is always associated with a brake actuation. Automated tests at specific times without deliberate brake actuation can then optionally be omitted.

A fault indication is given, for example, if the pressure predetermined by the pressure curve is not reached or is only reached after a delay because hydraulic fluid is leaking or the desired compression cannot be achieved due to air in the hydraulic system.

In general, this method of checking the braking system can detect a leak or low compression, broken down by specific brake circuits or sub-circuits of a brake circuit if necessary.

The braking system may also include a brake fluid sensor that measures the level of brake fluid in the pressure fluid reservoir. However, a more economical fluid level monitoring system may also be used, or the brake fluid sensor may be omitted entirely if the described method is performed regularly.

In braking systems in which the electrofluidic pressure-generating unit the braking force during normal operation, no additional components are required to carry out the method. The predetermined pressure curve, which replaces the braking request, is then applied to the brake circuits by the electrofluidic pressure-generating unit. The electrofluidic pressure-generating unit can be, for example, a known plunger.

The steps for carrying out the method can be easily stored as software in the memory of a suitable control unit of the braking system.

Optionally, the determined pressure values and fault indications are also stored in the memory of the control unit so that the behaviour of the braking system can be monitored over time and thus possible fault sources can be detected at an early stage.

A separate hydraulic test sequence for leak or compression detection can optionally be dispensed with.

In one aspect, the predetermined pressure curve comprises an amplification of the braking request by an amplification factor. The detected braking request is amplified sufficiently to contain a pressure above the detection threshold value. Such a pressure curve can be traversed in a short time. A check with such a predetermined pressure curve is also referred to below as a dynamic braking system test.

This method is applicable, for example, if the braking request correlates with a driving mode change at the start of the journey. In automatic vehicles, for example, the driver must press the brake pedal to switch from parking mode to driving mode. This braking request, i.e. in this case the actuation of the brake pedal, can be used to determine a predetermined pressure curve with a gain factor, to have it applied by the electrofluidic pressure-generating unit and to detect the pressure values of all or individual brake circuits. The time required for this is short enough to not cause any noticeable disruption when changing driving modes. In this way, the braking system can be routinely checked before starting to drive, which increases driving safety.

In addition, an automated check can be carried out, for example, after bleeding the braking system, changing the brake fluid or changing the brake pads, directly at the next start of a journey to ensure that the braking system has not been damaged during such a process and that no air has entered the hydraulic lines.

In another aspect, the predetermined pressure curve comprises the automated traversing of a predetermined pressure curve. Here, the pressure curve is precisely known, as it is completely predetermined. For example, a maximum pressure is quickly built up and kept constant for a certain period of time. This increases the measurement accuracy. This check usually requires more time than simply amplifying the braking request, but the accuracy can be higher or it is possible to check several brake circuits or sub-circuits one after the other. A check with such a predetermined pressure curve is also referred to below as a static braking system test.

A good opportunity to use a predetermined pressure curve in the form of a predetermined pressure curve arises when the braking request correlates with a driving mode change at the end of the journey. For example, as with the start of a journey in automatic vehicles, the driver must press the brake pedal to switch from driving mode back to parking mode. Since the vehicle is scheduled to remain in parking mode, a longer period of time can be used to check the braking system without the vehicle user noticing, which can also significantly exceed the period during which the driver presses the brake pedal. This provides enough time for a complete and thorough check of the braking system at the end of the journey.

Such braking processes when stationary also occur in electric vehicles, for example, due to the conditions of the driving mode change. Hydraulic braking is rare in electric vehicles, as the aim is to recover as much braking energy as possible through recuperation by the electric motor. However, during braking operations when changing driving modes, the hydraulic braking system (provided at least for emergencies) can be checked without any problems and without loss of recuperated electrical energy.

The method described can also be carried out in autonomous or semi-autonomous vehicles. In this case, the braking request when changing driving modes at the start and end of the journey is not triggered by the vehicle user, but by the autonomous system; the procedure is otherwise identical.

It is also conceivable that, when a fault indication is detected, especially in a suspected case, hydraulic braking during normal driving operation, of which the brake pressure exceeds the detection threshold value, could be used to verify the suspected case. In this case, however, the brake pressure curve is not changed in relation to the braking request, but only the braking request is compared with the pressure value achieved.

If each brake circuit has its own brake circuit valve in fluid communication with the electrofluidic pressure-generating unit and only the brake circuit valve for the corresponding brake circuit is opened for separate measurement, all brake circuits can be checked separately. If several or all brake circuits are to be checked at the same time, all corresponding brake circuit valves are therefore opened.

To perform a step-by-step check, the entire braking system is checked first, for example. To do this, all brake circuit valves are opened so that pressure is applied to all brake circuits simultaneously. If no deviation value above the threshold value is detected in the measured pressure values, it is assumed that the braking system is functioning properly and the check can be completed.

However, if a fault indication, i.e. a deviation value above the threshold value, is detected, the next step involves checking one of the brake circuits, for example the first brake circuit, separately. To do this, the brake circuit valve to the other, i.e. the second, brake circuit is closed so that the pressure is only applied to the first brake circuit to be measured. If no deviations to be taken into account, i.e. deviation values above the threshold value, are detected during this measurement, the first brake circuit is classified as functioning properly. Accordingly, it is also concluded that the second brake circuit is faulty.

However, if a deviation value exceeds the threshold value during this measurement, it is detected that the first brake circuit is defective.

In this case, the brake circuit valve to the first brake circuit is closed and the valve to the second brake circuit is opened, and the second brake circuit is checked separately. If no deviation value exceeding the threshold value is detected here, the second brake circuit is classified as functioning properly. However, if a fault indication is also detected during this measurement, it is assumed that both brake circuits are defective and that there is a serious fault in the braking system.

If, on the other hand, only one of the brake circuits is defective, it is possible to classify the fault as less serious and, if necessary, to continue operating the braking system via the electrofluidic pressure-generating unit using only the brake circuit that is functioning properly.

In known braking systems, each brake circuit can be coupled to several brake actuators, usually to the brake actuators of two vehicle wheels. In most cases, all brake actuators are located in their own sub-circuit with separately controllable valves. The separately controllable valves are, for example, known valves of the anti-lock braking system. Therefore, it is usually possible to check individual sub-circuits in the brake circuits, too. To check the individual sub-circuits, only the valves of the respective sub-circuit are opened.

This allows the step-by-step method described above to be further refined by also checking the individual sub-circuits in a brake circuit that has been found to be faulty by opening and closing the corresponding ABS valves. The check then provides fault indications for the individual brake actuators of the vehicle, which simplifies repair.

Since most checks do not detect any fault indications, the check is already completed after the overall system test and can be carried out in a short period of time, e.g. at the start of the journey.

In one aspect, the fault indications are categorized according to their relevance to operation of the braking system and may include less serious and serious fault indications. After a serious fault indication has been detected, the affected brake circuit or a sub-circuit of the affected brake circuit is optionally isolated, while if a less serious fault indication is detected, the braking system continues to be operated, via the electrofluidic pressure-generating unit, for example.

The categorization of fault indications can be easily implemented by using different threshold values for the deviation values.

In the case of a less serious fault indication, the braking system can thus continue to operate normally, with pressure being generated by the electrofluidic pressure-generating unit, using the remaining brake circuits or sub-circuits that are functioning properly. The vehicle user then notices practically no difference in driving behaviour; above all, the braking force assistance provided by the electrofluidic pressure-generating unit is still available to the vehicle user.

For example, only in the event of a serious fault indication is the system switched to push-through mode, in which the braking force is no longer supplied by the electrofluidic pressure-generating unit, but by a brake master cylinder connected to the brake pedal, via which the braking force must be applied manually in a purely mechanical manner, i.e. solely by the driver's foot pressure. This results in uncomfortable driving behaviour, which can be avoided in many cases by the method described above.

If the fault indications, e.g. during a check at the start of the journey, only give rise to a suspicion that there may be low compression or a leak, it is possible to carry out an automatic check of the braking system at the end of the journey. Here, for example, it would be conceivable to check all brake circuits and/or sub-circuits individually using a predetermined pressure curve and to compare the data obtained with previously stored data in order to detect a fault, e.g. even a gradual development of pressure loss. Such a suspected case exists, for example, if the brake pressure achieved is too low or drops too sharply, but this is still at the lower end of normal operating conditions and/or the deviation value only minimally exceeds the threshold value. For example, a note is stored in the control unit to perform a static braking system test at the end of the journey.

In this way, a false positive dynamic braking system test performed at the start of the journey can also be detected. This can be done without informing the driver and causing them concern with a false positive warning message.

A check using one of the methods described can be performed and repeated at specific times, for example, each time the driving mode is changed when the vehicle is started, occasionally when the driving mode is changed when the vehicle is parked, or as required, wherein the request may originate from the vehicle user and/or the braking system. For example, a dynamic braking system test can be performed by amplifying the braking request by a gain factor at the start of each journey. It is also possible to perform a static braking system test at specific intervals by running through a pressure curve at the end of the journey. In this way, the braking system can also be checked more thoroughly in suspected cases, for example.

To isolate a brake circuit or sub-circuit, the corresponding brake circuit valve and/or the corresponding ABS valves of the affected brake circuit or sub-circuits are kept permanently closed.

Pressure measurement can be carried out by detecting pressure values using pressure sensors on the individual vehicle wheels and/or by using a pressure sensor that detects an output pressure of the electrofluidic pressure-generating unit. In the first case, it would be conceivable to check several brake circuits or sub-circuits in parallel, at least in order to obtain an initial assessment of the fault indications. However, the sequential procedure described above also makes the method easy to implement in braking systems without their own pressure sensors on the brake actuators.

### BRIEF DESCRIPTION OF THE DRAWINGS

The invention will be described hereinafter in greater detail on the basis of an exemplary embodiment with reference to the accompanying figures, in which:

FIG. 1 is a schematic representation of a vehicle braking system with which a method according to the invention can be carried out;

FIG. 2 is a schematic representation of a braking process of the method according to the invention when the vehicle is stationary, with a predetermined pressure curve and an increase in the desired braking force by a gain factor;

FIG. 3 is a schematic representation of a braking process of the method according to the invention when the vehicle is stationary with a predetermined pressure curve, passing through a predetermined pressure curve;

FIG. 4 is a schematic representation of hydraulic service braking during normal driving without predetermined pressure curve; and

FIG. 5 schematically shows a sequence of a method according to the invention.

### DESCRIPTION

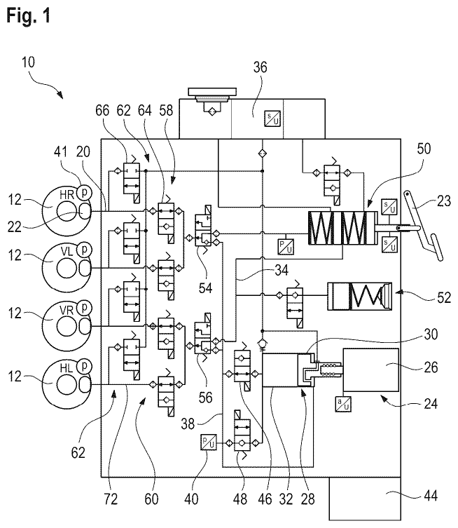

FIG. 1 shows a braking system 10 for carrying out a braking method and a method for checking the braking system.

For reasons of clarity, not all identical components are provided with reference signs.

The braking system 10 is here designed for a vehicle with four wheels 12 (rear right, front left, front right and rear left). All four wheels 12 can be braked by means of the braking system 10. For this purpose, the braking system 10 has a total of four pressure ports 20 for in each case one brake actuator 22 per wheel 12. Each brake actuator 22 can be selectively pressurized and depressurized by means of the braking system 10.

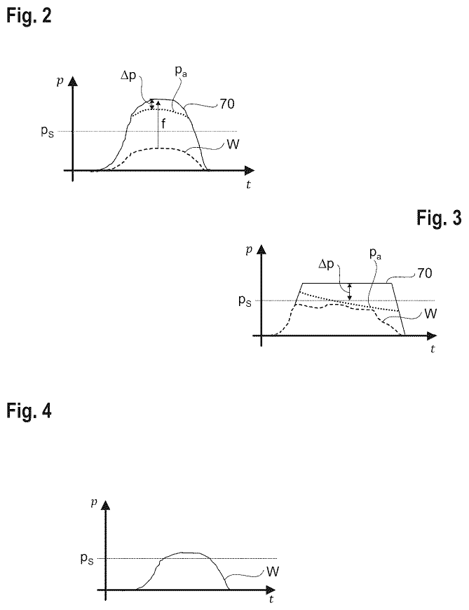

To operate the braking system 10, the vehicle has a brake pedal 23, which the driver can use to indicate a braking request W (see also FIGS. 2 to 4) corresponding to a specific braking force and thus a deceleration of the vehicle.

In this example, the braking system 10 is designed for a brake-by-wire method. The braking request W is therefore transmitted electronically in a known manner from the brake pedal 23 to an electrofluidic pressure-generating unit 24 of the braking system 10, which then provides the corresponding pressure in the braking system 10.

The electrofluidic pressure-generating unit 24 is a known plunger here and essentially comprises an electric drive motor 26, which is coupled in a drive-related manner to a piston-cylinder unit 28 with a linearly movable piston 30. The piston 30 is guided in a cylinder 32 with two chambers, which can be supplied with pressure fluid from a pressure fluid reservoir 36 via a supply line 34 on the one hand and can feed pressure fluid under pressure into a main line 38 on the other hand. This design also makes it possible in a known manner for the piston 30 to be able to feed pressure fluid under pressure into the main line 38 both in the case of a stroke in a direction pointing away from the drive motor 26, and in the case of a stroke in a direction pointing towards the drive motor 26. In the embodiment illustrated, the electrofluidic pressure-generating unit 24 acts via a first supply valve 46 and a second supply valve 48 on the main line 38. The piston-cylinder unit 28 is here moreover designed to receive pressure fluid from the main line 38.

The electrofluidic pressure-generating unit 24 discharges hydraulic fluid at a known pressure. A pressure sensor 40 is arranged in the main line 38 and detects the actual hydraulic pressure pₐ in the main line 38.

The pressure sensor 40 and the drive motor 26 of the electrofluidic pressure-generating unit 24 are connected to a control unit 44, which receives sensor data from the pressure sensor 40 and can control the drive motor 26.

Optionally, additional pressure sensors 41 are arranged on the individual brake actuators 22 and are also connected to the control unit 44.

The control unit 44 is designed to control the electrofluidic pressure-generating unit 24, more precisely its drive motor 26, in such a way that a desired hydraulic pressure is predetermined in the main line 38, even over a predetermined period of time.

The brake pedal 23 is also mechanically coupled to a master cylinder unit 50 for purely mechanical emergency operation (so-called push-through operation). The master cylinder unit 50 comprises, for example in a known manner, a fluidic brake master cylinder equipped with a first piston and a second piston. The master cylinder unit 50 is fluidically connected to the pressure fluid reservoir 36.

During normal operation, the master cylinder unit 50 is only used to generate the desired braking force W. For this purpose, it is also coupled to a simulator unit 52 in a known manner, in addition to the brake pedal 23.

Both the electrofluidic pressure-generating unit 24 and the master cylinder unit 50 can thus be used to selectively pressurize a volume flow of pressure fluid taken from the pressure fluid reservoir 36 in the main line 38.

The main line 38 leads to two brake circuit valves 54, 56, which define a first brake circuit 58 and a second brake circuit 60. By closing one of the brake circuit valves 54, 56, the two brake circuits 58, 60 can be fluidically decoupled and connected individually to the main line 38.

The first brake circuit 58 comprises here the pressure ports 20 for the rear right and front left wheels 12. The second brake circuit 60 accordingly comprises the pressure ports 20 for the front right and rear left wheels 12. In normal operation, both brake circuits 58, 60 are pressurized. However, it is possible to operate the braking system 10 with only one brake circuit 58, 60 and still brake the vehicle safely.

Fluidically connected to the two brake circuit valves 58, 60 in the direction of the pressure ports 20 in each brake circuit 58, 60 is a pressure modulation unit 62 which, together with the control unit 44 and the brake actuators 22, in a known manner provides the functionality of an anti-lock braking system. Associated with each pressure port 20 here is a valve 64 which is formed here by an ABS shut-off valve, and a valve 66 which is formed here by an ABS discharge valve. Such valve switching is known per se and is therefore not explained in more detail.

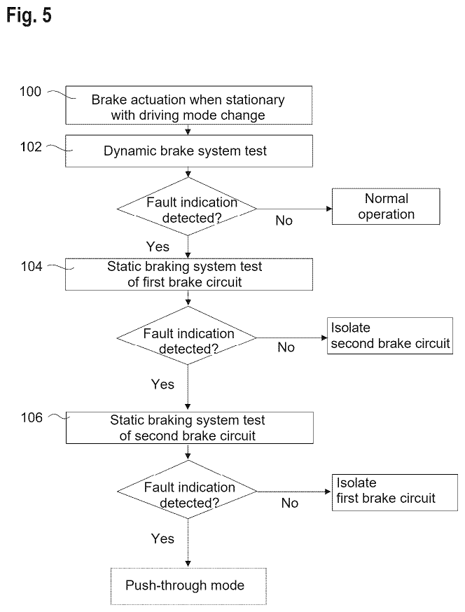

In order to check the braking system 10 for functionality, in particular for leaks or air in the hydraulic lines, a suitable program is stored in a non-volatile memory of the control unit 44, with which suitable checking methods can be carried out. The steps of a possible checking method are shown as an example in FIG. 5.

To check the braking system 10, brake actuation is generally used when the vehicle is stationary.

In general, in an automatic vehicle, basic brake actuation is used here when changing the driving mode from parking mode to driving mode at the start of the journey and from driving mode to parking mode at the end of the journey.

The control unit 44 detects such a driving mode change and initiates a checking method if necessary.

The brake application during the driving mode change is detected as a braking request W. The braking request W is generated either when a driver of the vehicle presses the brake pedal 23 or when an autonomous control unit (not shown) sends a corresponding signal to the electrofluidic pressure-generating unit 24.

In a first variant, the braking system 10 is checked as a dynamic braking system test (see FIG. 2). This dynamic braking system test is performed here at the start of the journey and optionally at each change of driving mode from parking mode to driving mode.

In the dynamic braking system test, the braking force defined by the braking demand W is increased by a suitable amplification factor f (shown in FIG. 2 for a pressure p corresponding to the braking force). This ensures that the pressure p exceeds a determined detection threshold value pₛ. The detection threshold value pₛ is selected so that sufficient pressure builds up in the hydraulic lines of the braking system 10 to reliably detect faults, i.e. air pockets or leaks, within the time available for the braking system test.

The pressure p of the hydraulic fluid delivered to the main line 38 thus follows a pressure curve 70 predetermined by the control unit 44 over time t, which corresponds to the braking demand W amplified by a factor f. The pressure p is predetermined with sufficient accuracy at each time t by the electrofluidic pressure-generating unit 24, but is not controlled here. The pressure curve 70 is therefore precisely known.

The pressure sensor 40 (and/or optionally the pressure sensors 41) measures the actual pressure pₐ present in the main line 38 over the course of the braking system test. The deviations between the predetermined pressure curve 70 and the actual measured pressure pₐ are detected and evaluated as one or more deviation values Δp.

Optionally, all brake circuits 58, 60 of the braking system 10 are checked simultaneously. For this purpose, both brake circuit valves 54, 56 are opened so that both brake circuits 58, 60 are pressurized. In addition, the valves 64 of sub-circuits 72 are opened, while the valves 66 are closed, so that all four sub-circuits 72 (each comprising a brake actuator 22, a valve 64 and a valve 66) are pressurized.

If an excessive deviation value Δp is detected during the check, the affected brake circuit 58, 60 or sub-circuit 72 is optionally shut down and decoupled from the rest of the braking system 10 in terms of flow. For this purpose, for example, suitable valves are kept permanently closed or open by the control unit 44 until the defect has been rectified.

In a second variant, the check is performed as a static braking system test (see FIG. 3). This static braking system test is performed here, for example, when changing the driving mode at the end of the journey.

When the vehicle is parked, more time is available than at the start of the journey, so that the total duration of the static braking system test can be longer than that of the dynamic braking system test.

For the static braking system test, the detected brake demand W is replaced by a predetermined pressure curve 70, which is formed by a pressure curve predetermined in terms of time and absolute pressure level. This pressure curve is automatically traversed by the electrofluidic pressure-generating unit 24. In this pressure curve, a maximum pressure is quickly built up and maintained constant over a predetermined period of time.

As in the dynamic braking system test, the current pressure pₐ in the main line 38 is measured by the pressure sensor 40 (and/or optionally by the pressure sensors 41) and deviations are detected and evaluated as deviation values Δp and stored in the control unit 44.

It is possible to perform a static braking system test at each driving mode change from driving mode to parking mode at predetermined intervals or upon input from a vehicle user.

Optionally, hydraulic braking operations occurring during normal driving, in which the brake pressure rises above the threshold value pₛ without any change in the brake demand W, can also be used to check the braking system 10 (indicated in FIG. 4). In such braking operations, the applied pressure is also predetermined by the electrofluidic pressure-generating unit 24, while the actual pressure pₐ can be measured by the pressure sensor 40.

FIG. 5 shows a possible sequence of events during a check of the braking system 10.

At the start of the journey, in a first step 100, it is detected that there is a brake actuation when the vehicle is stationary during a driving mode change with a braking request W. Now, in step 102, a dynamic braking system test is carried out as described above in the first variant. Optionally, all brake circuits 58, 60 of the braking system 10 are checked simultaneously.

The braking request W is replaced by the predetermined pressure curve 70, in which the detected braking request W is amplified by the amplification factor f.

Deviations of the currently measured pressure pₐ from the predetermined pressure curve 70 are detected as deviation values Δp and evaluated by the control unit 44.

If the deviation value Δp remains below a predetermined threshold value, the control unit 44 decides that the braking system 10 is functioning properly. A corresponding log entry is recorded in a permanent memory of the control unit 44, for example. The braking system 10 is operated in normal mode. The check goes unnoticed by the vehicle user.

However, if the deviation value Δp exceeds the threshold value, the control unit 44 decides that a fault indication has been detected and that the proper functioning of the braking system 10 is impaired.

In this case, a static braking system test is performed directly here as step 104.

This braking system test is only performed here for the first brake circuit 58.

To do this, the brake circuit valve 56 is closed so that only the first brake circuit 58 is pressurized.

The control unit 44 controls the electrofluidic pressure-generating unit 24 in such a way that it outputs the predetermined pressure curve as the predetermined pressure curve 70 as described above. The current pressure pₐ is measured by the pressure sensor 40, and the deviation is determined and evaluated as a deviation value Δp.

If no fault indication is detected, the second brake circuit 60 is isolated, e.g. by keeping the brake circuit valve 56 closed during further driving. The braking system 10 is operated exclusively with the first brake circuit 58, but continues to be operated via the electrofluidic pressure-generating unit 24. This means that the braking system 10 can continue to be used in limited normal operation.

In addition, a warning message is issued and a corresponding entry is stored in the memory of the control unit 44.

However, if a fault indication is detected for the first brake circuit 58, a further static braking system test is performed for the second brake circuit 60 (step 106).

If this remains fault-free, the fault lies in the first brake circuit 58, and this is isolated as described above in a similar manner for the second brake circuit 60. The braking system 10 continues to operate in restricted normal mode using only the second brake circuit 60.

Of course, the second brake circuit 60 could also be checked first.

However, if there is also a fault in the second brake circuit 60, the control unit 44 decides, optionally depending on the size of the deviation values Δp, whether the braking system 10 can still be operated in purely mechanical push-through mode via the master cylinder unit 50 and switches the valves of the braking system 10 accordingly. Here too, an error message is issued and an entry is stored in the memory of the control unit 44.

The fault indications are optionally categorized, for example into suspected cases, less serious fault indications and serious fault indications.

Suspected cases describe deviation values Δp which, for example, are only slightly above the threshold value and thus represent only a slight deviation of the current pressure pₐ from the predetermined pressure curve 70. Suspected cases are indications that a defect could develop. However, the braking system 10 can remain in normal operation under observation.

If a suspected case has been detected at the start of the journey, it is possible to automatically perform a static braking system test at the end of the journey to check this suspected case.

In addition, the control unit 44 can initiate a further check in this case during normal operation with suitable hydraulic braking operations. Corresponding entries are stored here in the memory of the control unit 44 so that the development of a possible fault can be tracked over time.

A less serious fault indication is, for example, a leak or insufficient compression in only one brake circuit 58, 60 or only certain sub-circuits 72. In this case, it is usually possible to continue operating the braking system 10 via the electrofluidic pressure-generating unit 24, if necessary by isolating the affected sub-circuits 72 of the affected brake circuit 58, 60.

Serious fault indications, on the other hand, describe, for example, leaks in both brake circuits 58, 60 and cause the control unit 44 to at least switch the braking system 10 to emergency mode, in which pressure is generated purely mechanically via the brake pedal 23 and the master cylinder unit 50.

In the case of less serious fault indications and serious fault indications, warning messages are also issued to the vehicle user and corresponding entries are made in the memory of the control unit 44.

1. Method for checking a vehicle's braking system for leaks, wherein the braking system has a first and a second brake circuit, each with at least one pressure port, wherein each of the pressure ports can be coupled to an associated brake actuator of a wheel of the vehicle, as well as an electrofluidic pressure-generating unit that is in fluid communication with the first and second brake circuits, with the steps of:
detecting a braking request when the vehicle is stationary,
modifying the braking request by means of a predetermined pressure curve which includes a pressure above a detection threshold value, and controlling the electrofluidic pressure-generating unit with the predetermined pressure curve,
detecting pressure values associated with the first and/or second brake circuit,
comparing the pressure values with the predetermined pressure curve and determining deviation values, and
detecting a fault indication if at least one deviation value exceeds a predetermined threshold value.

2. Method according to claim 1, wherein the predetermined pressure curve comprises an amplification of the braking request by an amplification factor.

3. Method according to claim 1, wherein the braking request correlates with a driving mode change at the start of the journey.

4. Method according to claim 1, wherein the predetermined pressure curve comprises the automated traversing of a predetermined pressure curve.

5. Method according to claim 1, wherein the braking request correlates with a driving mode change at the end of the journey.

6. Method according to claim 3, wherein the fault indications comprise suspected cases and, in the event that a suspected case is detected at the start of the journey, an automatic check of the braking system is carried out at the end of the journey.

7. Method according to claim 1, wherein each brake circuit is in fluid communication via its own brake circuit valve with the electrofluidic pressure-generating unit and in each case only the brake circuit valve for the corresponding brake circuit is opened for separate measurement.

8. Method according to claim 1, wherein each brake circuit can be coupled to a plurality of brake actuators and all brake actuators are in their own sub-circuit with separately controllable valves and in each case only the valves of the respective sub-circuit are opened.

9. Method according to claim 1, wherein the fault indications are categorized according to a relevance for operation of the braking system and comprise less serious and more serious fault indications and once a fault indication has been detected
the affected brake circuit or a sub-circuit of the affected brake circuit is isolated, and
if a less serious fault indication is detected, the braking system continues to be operated via the electrofluidic pressure-generating unit.

10. Method according to claim 1, wherein pressure values are detected by pressure sensors at the individual brake actuators and/or by a pressure sensor, which detects an output pressure of the electrofluidic pressure-generating unit.
